(19) United States
(12) Patent Application Publication
(10) Pub. No.: US 2011/0231583 A1
(43) Pub. Date: Sep. 22, 2011

(54) COMPUTER SYSTEM AND METHOD OF SIMULATING KEYBOARD INPUT

(75) Inventor: YING-CHUAN TSAI, Tu-Cheng (TW)

(73) Assignee: HON HAI PRECISION INDUSTRY CO., LTD., Tu-Cheng (TW)

(21) Appl. No.: 12/762,492

(22) Filed: Apr. 19, 2010

(30) Foreign Application Priority Data
Mar. 16, 2010 (CN) 201010126243.1

(51) Int. Cl. G06F 3/00; G06F 9/45; G06F 13/20

(52) U.S. Cl. 710/16; 703/22; 710/313

(57) ABSTRACT

A computer system includes a storage device and a computer. The storage device stores at least one key code. The computer executes at least one command corresponding to the at least one key code, and the storage device sends the at least one key code to the computer. The computer executes the at least one command according to the at least one key code, wherein the key code simulates keyboard input.

### BACKGROUND

1. Technical Field

The present disclosure relates to a computer system and a method of simulating keyboard input.

2. Description of Related Art

Current virtual keyboards are accomplished by software programs in computers. Virtual keyboards must be run using an operating system in the computer. For example, a small keyboard program on a screen is implemented under Windows operating system in the computer. The small keyboard program can allow input like an actual keyboard for users. But without an operating system, virtual keyboards cannot be implemented.

### BRIEF DESCRIPTION OF THE DRAWINGS

FIG. 1 is a schematic view of a computer system in accordance with one embodiment.

FIG. 2 is a flowchart of a method of simulating keyboard input according to an embodiment.

FIG. 3 is a schematic view of a method of simulating keyboard input according to an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

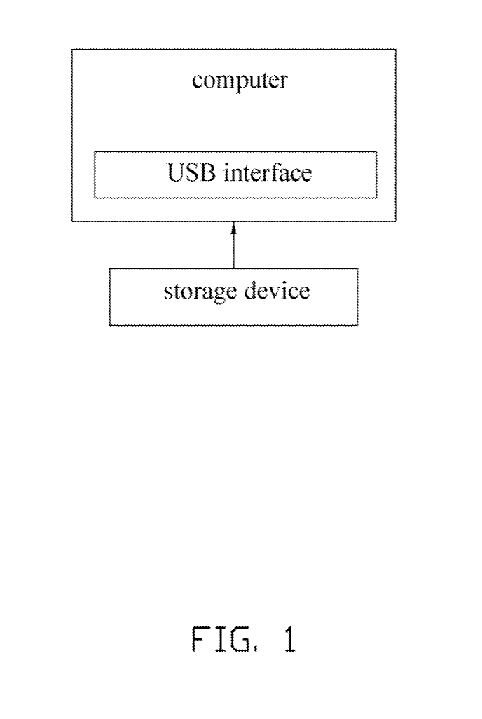

Referring to FIG. 1, a computer system includes a computer and a storage device. The computer has a Universal Serial Bus (USB) interface. The storage device also has a USB interface connectable to the computer's USB interface. In one embodiment, the storage device is a C8051F340 chip. C8051F340 devices are fully integrated mixed-signal System-on-a-Chip Multipoint Control Unit (MCU) designed specifically for USB applications. A software program of a method of simulating keyboard input is burned into or stored in the storage device. The storage device can automatically send key codes to a computer when it is connected to the computer and the computer is turned on. The computer executes commands corresponding to the key codes. The storage device can send the key codes to the computer before an Operating System (OS) of the computer is loaded.

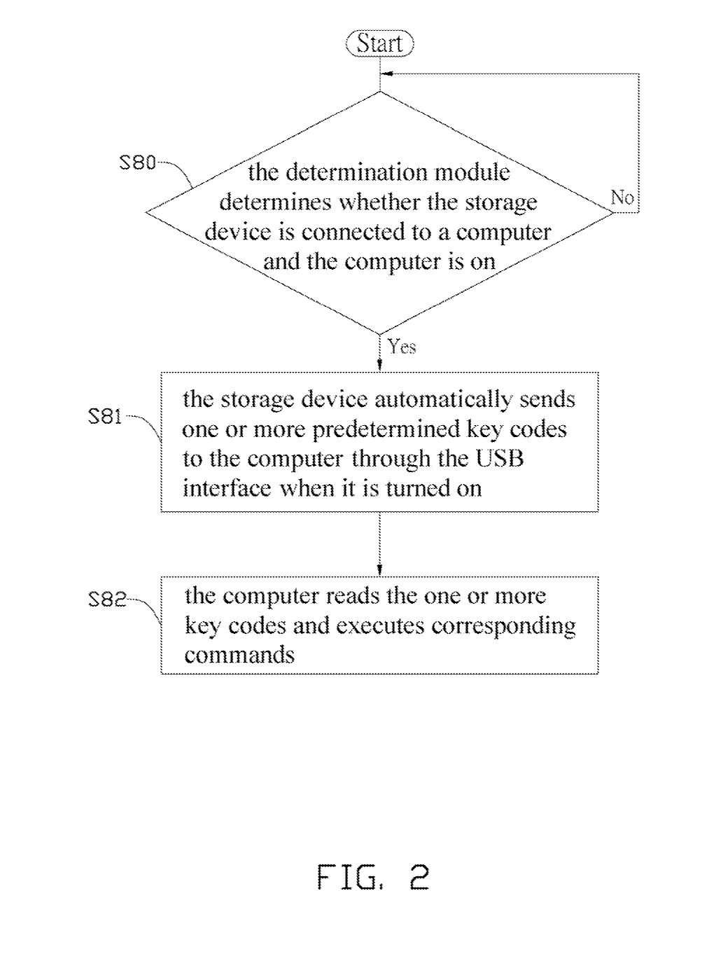

Referring to FIG. 2, one embodiment of a method of simulating keyboard input includes the following blocks.

In block S80, the storage device has a determination module. The determination module determines whether the storage device is connected to a computer and the computer is on. If no, repeat; if yes, go on to S81.

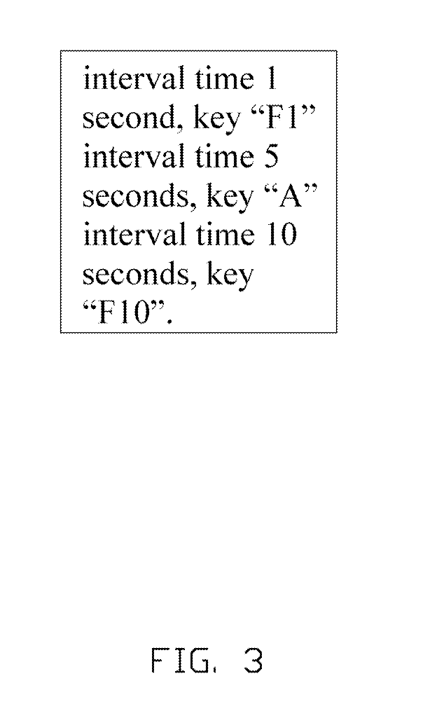

In block S81, the storage device automatically sends one or more predetermined key codes to the computer through the USB interface when it is turned on. An interval time of every two key codes may exist, as shown in FIG. 3. FIG. 3 shows an example of what the storage device can send in S81 as the key codes to the computer every the interval time. For example, after 1 second interval time, the storage device sends “F1” key code to the computer When the interval time has arrived, the storage device automatically sends the one or more predetermined key codes to the computer. The storage device can send one or more predetermined key codes to the computer.

In block S82, the computer reads the one or more key codes and executes corresponding commands.

FIG. 3 shows the input information in the storage device. After the computer is started up, the storage device sends the input information to the computer. After 1 second interval time, the storage device sends “F1” key code to the computer. After 5 seconds interval time, the storage device sends “A” key code to the computer. After 10 seconds interval time, the storage device sends “F10” key code to the computer. The computer executes the corresponding commands according to the key codes.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computer system comprising:
a storage device storing at least one key code;
a computer capable of executing at least one command corresponding to the at least one key code;
wherein the storage device is capable of sending the at least one key code to the computer, the computer is capable of executing the at least one command according to the at least one key code, wherein the key code simulates keyboard input.

2. The computer system of claim 1, wherein the storage device is capable of sending the at least one key code to the computer when the computer is started up.

3. The computer system of claim 1, wherein the storage device is capable of sending the at least one key code to the computer when no operating system is running.

4. The computer system of claim 1, wherein the computer comprises a universal serial bus interface connected to the storage device.

5. The computer system of claim 1, wherein the storage device comprises a determination module, and the determination module is capable of determining whether the storage device is connected to the computer.

6. A method of simulating keyboard input, the method comprising:
storing at least one key code through a storage device;
sending the at least one key code to a computer;
executing at least one command according to the at least one key code, wherein the key code simulates keyboard input.

7. The method of claim 6, wherein the storage device sends the at least one key code to the computer when the computer is started up.

8. The method of claim 6, wherein the storage device sends the at least one key code to the computer when no operating system is running.

9. The method of claim 6, wherein the computer comprises a universal serial bus interface connected to the storage device.

10. The method of claim 6, wherein the storage device comprises a determination module, and the determination module determines whether the storage device is connected to the computer.
